(19) United States
(12) Patent Application Publication
(10) Pub. No.: US 2011/0005414 A1
(43) Pub. Date: Jan. 13, 2011

(54) Low Friction Roll

(75) Inventors: Juergen Frauenknecht, Augsburg (DE); Roland Palatzky, Neusass (DE)

Correspondence Address: FISH & RICHARDSON P.C. (BO), P.O. BOX 1022, MINNEAPOLIS, MN, 55440-1022, US

(73) Assignee: Texmag GmbH Vertriebsgesellschaft

(21) Appl. No.: 12/824,276

(22) Filed: Jun. 28, 2010

(30) Foreign Application Priority Data
Jul. 13, 2009 (EP) 09165302.2

(51) Int. Cl. B41F 13/20; F16C 13/00; B05C 1/08

(52) U.S. Cl. 101/219; 492/47; 492/18; 492/48; 101/216

(57) ABSTRACT

A roll assembly with a roll and rotational bearings. The rolls exhibits a reinforcement with a fiber composite material which is located inside the roll. The reinforcement is located between the rotational bearings, and designed such that the roll is reinforced against bending stress. The roll assembly is optimized with a low moment of inertia and high stiffness in order to allow the roll assembly to be stopped faster in the event of malfunction and to ensure that the roll exhibits low bowing in the operational state.

This application claims the benefit under 35 U.S.C. §119 of European Patent Application Serial Number 09165302.2, filed Jul. 13, 2009 and entitled “Leichtlaufwalze,” the contents of which are incorporated herein by reference

This invention pertains to a roll assembly used in printing presses, in particular in rotary printing machines.

Rotary printing machines use a large number of deflection rolls, which are not actively driven and which cannot be actively stopped. In the event of a malfunction (e.g. in the event of paper break), the rotary printing machine must be stopped. Since rotary machines are often operated at relatively high paper running speeds (e.g. 1,000 m/min or 18 in/sec), the stopping procedures take relatively long and the paper waste is substantial (sometimes more than 100 m of paper).

Known from the state of the art are various designs of roll assemblies being used in printing machines, in particular in rotary printing machines.

### SUMMARY OF THE INVENTION

A roll assembly exhibiting one roll and two rotational bearings. The invention provides for the roll to exhibit fiber composite reinforcement located inside the roll. This reinforcement is preferably positioned between the rotational bearings and designed such that the roll is enforced against bending stress.

The reinforcement of a fiber composite material may have different designs. For example, the reinforcement may be a pipe made of a fiber composite material laying snug against the inside of the roll. Alternatively or in addition, the reinforcement may exhibit strips of a fiber composite material running parallel to the roll axis and configured around the radius of the roll. If strips are used, the assembly may also provide a support pipe to support the fiber composite strips from the inside.

The reinforcement with a fiber composite material increases the stiffness of the roll assembly, whereby the roll with the reinforcement simultaneously exhibits a relatively low moment of inertia. This means that in the event of a malfunction, the roll and/or the rotary printing machine with one or multiple rolls designed according to the invention can be stopped faster than is possible for roll assemblies according to the current state of the art, wherein the breaking force is transmitted via the paper web.

As a result of the invention, the reinforcement also minimizes the bowing of the roll, which is generated by the force of the paper web, to ensure that the paper web will not be partially stretched by its deflection by the roll. That is because at a point of high bowing, the distance the paper web needs to travel is smaller than at a point with low bowing.

The rotational bearings of the roll assembly can be positioned on a (stationary) shaft extending along the entire length of the roll. The rotational bearings are preferably located at one end of the roll. A stationary shaft allows the rotational bearings to be advantageously supported, wherein the end points of the shaft anchoring the roll assembly do not have to absorb bending forces.

Alternatively, the rotational bearings may be located on shaft sections that are separate from each other. This has the disadvantage that this assembly may be potentially more difficult to assemble, and that the sections of the shaft will also need to absorb bending forces. There is, however, the advantage that the reinforcement strips rotating together with the roll during operation can extend beyond the center since no continuous, stationary shaft is in the way.

According to the invention, the entire roll assembly was optimized in order to achieve smallest bowing possible. In doing so, the length of the roll, the position of the rotational bearings, the wall thicknesses of the roll, and the reinforcement with fiber composite material were all considered. It was determined that the favorable ratio of the distance of the radial line of action of the rotational bearing to the end of the roll to the total length of the roll is in the range of 0.015 to 0.05, in particular from 0.03 to 0.04, in particular about or exactly at 0.035. The ratio of the outer diameter of the roll to the total length of the roll is preferably in the range of 0.03 to 0.1, in particular from 0.04 to 0.07, in particular about 0.05 to 0.06, preferably about or exactly at 0.054. The ratio of the wall thickness of the roll between the rotational bearings in relation to the outer diameter of the roll is in the range of 0.01 to 0.08, in particular at 0.02 to 0.06, in particular at about 0.015 to 0.04, preferably about or exactly 0.03. The ratio of the wall thickness of the fiber composite pipe to the wall thickness of the roll in the area between the rotational bearings is in the range of 0.2 to 1.0, in particular from 0.5 to 0.9, in particular at about 0.6 to 0.8, preferably about or exactly at 0.71.

Located at both ends of the shafts are preferably roll covers with an air gap between the roll covers and the roll. The air gap reaches around the circumference and lies in the range of 0.3 to 2 mm, in particular in the range of 0.5 to 1.8 mm, in particular from 0.9 to 1.4 mm, preferably about or exactly at 1.25 mm. The stationary roll covers and the rotating motion of the roll prevent dirt from entering the inside of the roll.

Materials to be used for the reinforcement with fiber composite may be multi-filament carbon fibers or polyacrylnitrile-based fibers, which are preferably carbonized by pyrolysis or graphitized into Ultra High Modulus (UHM) fibers. These fibers can be embedded into a matrix, in particular into a thermoset matrix or a resin matrix (typically epoxy resin).

The fibers in the entire enforcement are preferably directed into the longitudinal direction (in relation to the roll shaft). When strips are used, the fibers can also be at an angle of 30-60° to the longitudinal direction and possibly cross-wise.

### BRIEF DESCRIPTION OF THE FIGURES

FIG. 1 shows a longitudinal section through a roll according to the first embodiment of this invention;

FIG. 2 shows a cross-sectional view of a roll according to the embodiment shown in FIG. 1;

FIG. 3 shows a longitudinal section through a roll according to a second embodiment of this invention;

FIG. 4 shows a longitudinal section through a roll according to a third embodiment of this invention;

FIG. 5 shows a cross-sectional view of a roll according to the embodiment shown in FIG. 4;

FIG. 6 shows a longitudinal section through a roll according to a fourth embodiment of this invention;

FIG. 7 shows a cross-sectional view of a roll according to the embodiment shown in FIG. 6;

FIG. 8 shows a longitudinal section through a roll according to a fifth embodiment of this invention;

FIG. 9 shows a cross-sectional view of a roll according to the embodiment shown in FIG. 8.

### DETAILED DESCRIPTION OF THE EMBODIMENTS

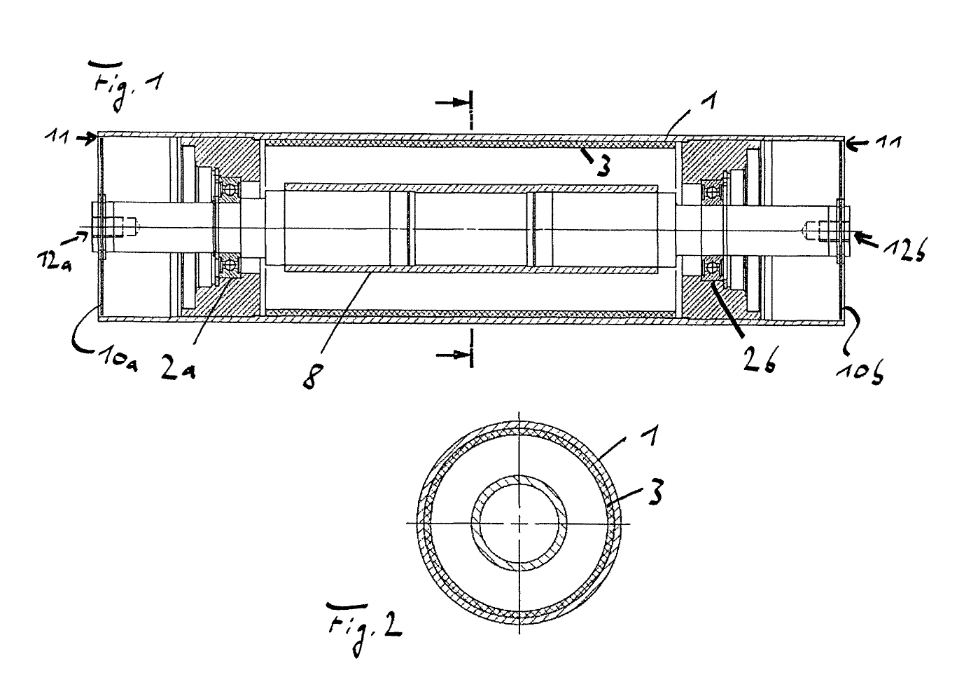

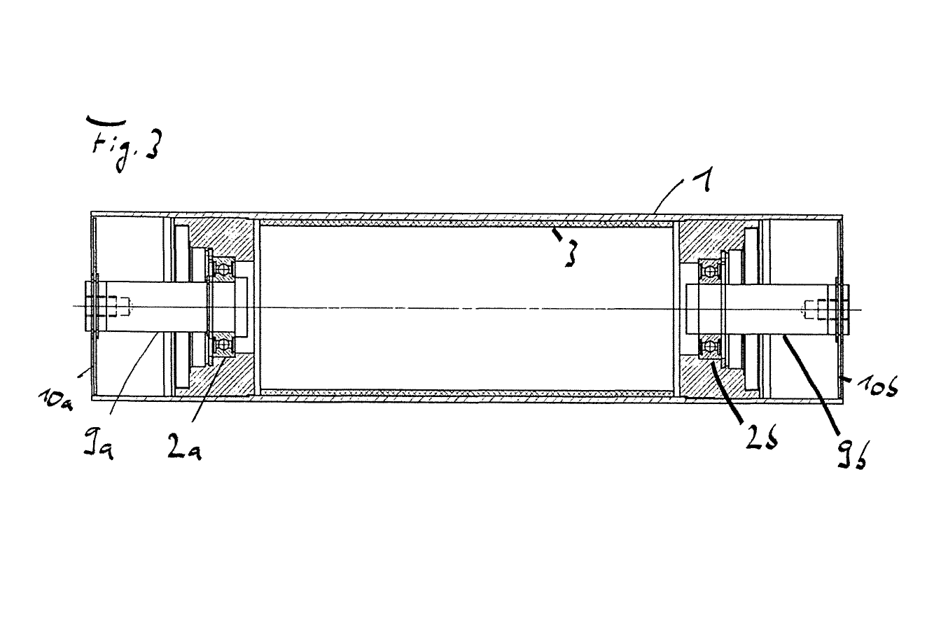

FIG. 1 and FIG. 2 show a longitudinal and a cross-sectional view of the roll according to a first embodiment of this invention. The shown roll assembly exhibits a roll 1 and two rotational bearings 2a, 2b. According to the invention it is provided that the roll 1 exhibits a reinforcement with a fiber composite material positioned inside the roll 1. The reinforcement is located preferably between the rotational bearings 2a, 2b and configured such that roll 1 is reinforced against bending stress.

In the embodiment shown in FIG. 1, the reinforcement is composed of a pipe 3 of a fiber composite, which is fitted against the inside of the roll 1. As already stated, the reinforcement leads to a high stiffness of the roll assembly wherein the roll with the reinforcement simultaneously exhibits a relatively low moment of inertia. Therefore, a roll and/or a rotary printing machine with one or more inventive roll assemblies can in the event of a malfunction faster be stopped than is possible in the state of the art, wherein the breaking force is transmitted via the paper web. The reinforcement furthermore minimizes the bowing of the roll generated by the force of the paper web to prevent the paper web from partially be stretched by the bowing. Because at a point with a large deformation the distance the paper web must travel is shorter than at a point with a small deformation.

The rotational bearings 2a, 2b of the roll assembly are in FIG. 1 mounted to a stationary shaft 8, which extends along the entire length of the roll. The rotational bearings 2a, 2b are located at the ends of the roll, i.e. on the right side and on the left side. With a stationary Axle, the rotational bearings can be advantageously supported, wherein the end points of the shaft for the anchoring of the roll assembly do not need to absorb bending forces.

In the invention, the entire roll assembly was optimized in order to achieve the smallest possible bowing. In doing so, the length of the roll, the position of the rotational bearings, the wall thicknesses of the roll and the reinforcement with fiber composite where taken into consideration. In doing so it was determined that the ratio of the distance of the radial line of action of the rotational bearing to the end the roll in relation to the entire length of the roll is advantageously at about 0.035. The ratio of the outer diameter of the roll in relation to the total length of the roll is most advantageously about 0.054. The ratio of the wall thickness of the roll in the area between the rotational bearings in relation to the outer diameter of the roll is about 0.03. The ratio of the wall thickness of the pipe of fiber composite in relation to the wall thickness in the area between the rotational bearings is about 0.71.

Provided at the ends of the shaft are preferable roll covers 10a, 10b with an air gap 11 between the roll covers 10a, 10b. The air gap runs around the circumference and is about 1.25 mm. The effect of the stationary roll covers and the rotating roll prevents dirt from entering the inside of the roll assembly.

FIG. 3 shows a longitudinal sectional view of a roll assembly according to a second embodiment of this invention. This embodiment is identical to the first embodiment with the exception that no continuous shaft is present. Instead, the rotational bearings 2a, 2b are configured on the shaft sections 9a, 9b, which are separate from each other.

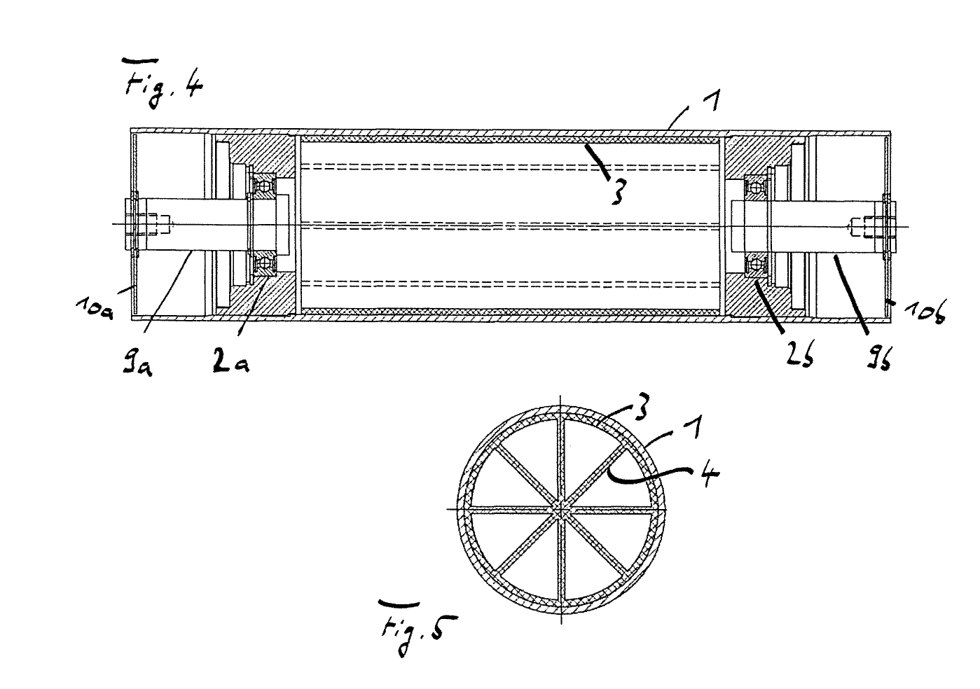

FIG. 4 and FIG. 5 show a longitudinal and cross-sectional view of a roll assembly according to a third embodiment of this invention. This embodiment is identical to the second embodiment, wherein the reinforcement also exhibits strips 4 of a fiber composite, which are running parallel to the roll axis and which are configured inside the roll 1 around the radius.

As shown in FIG. 5, the strips extend beyond the Center of the roll. As already stated, this has the disadvantage that the assembly potentially requires more effort, and that the shaft sections must also absorb bending stress due to the absence of a continuous shaft. This however, has the advantage that the strips 4, which rotate together with the roll in the operating state, have a high reinforcing effect.

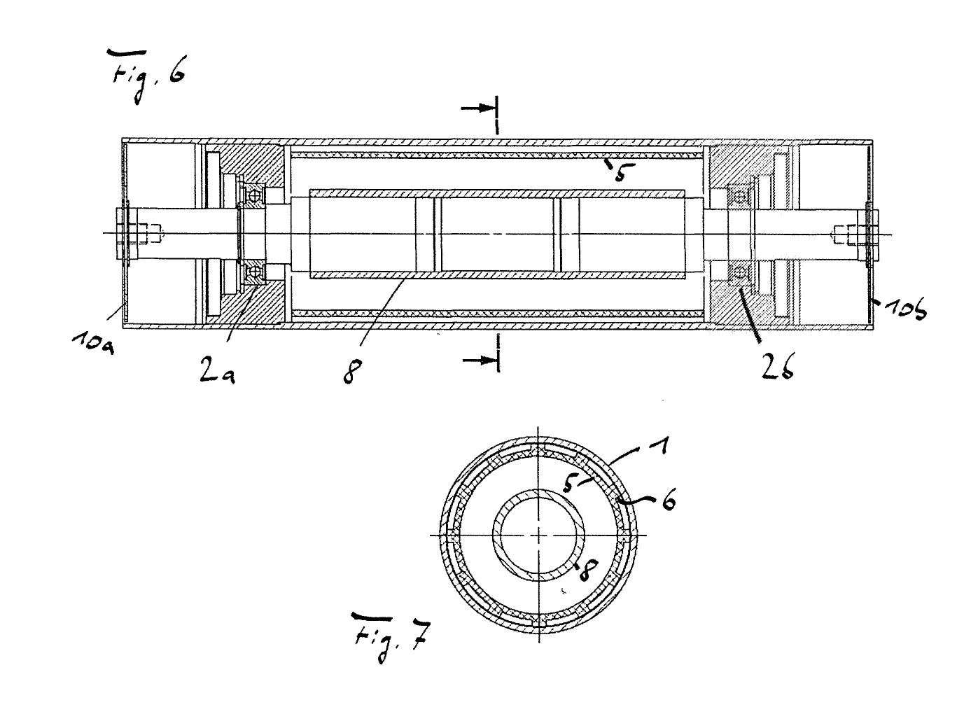

FIG. 6 and FIG. 7 show a longitudinal or cross-sectional view of a roll assembly according to a fourth embodiment of this invention. In this embodiment, the strips 6 are also provided but in this case do not extend beyond the center of the roll. In this case, for the reinforcement by way of the strips 6 an additional supporting pipe 5 has been provided in order to support the strips 6 of fiber composite from the inside. The supporting pipe can also be of fiber composite. Provided in addition may also be a pipe 3 as is the case in the first embodiment.

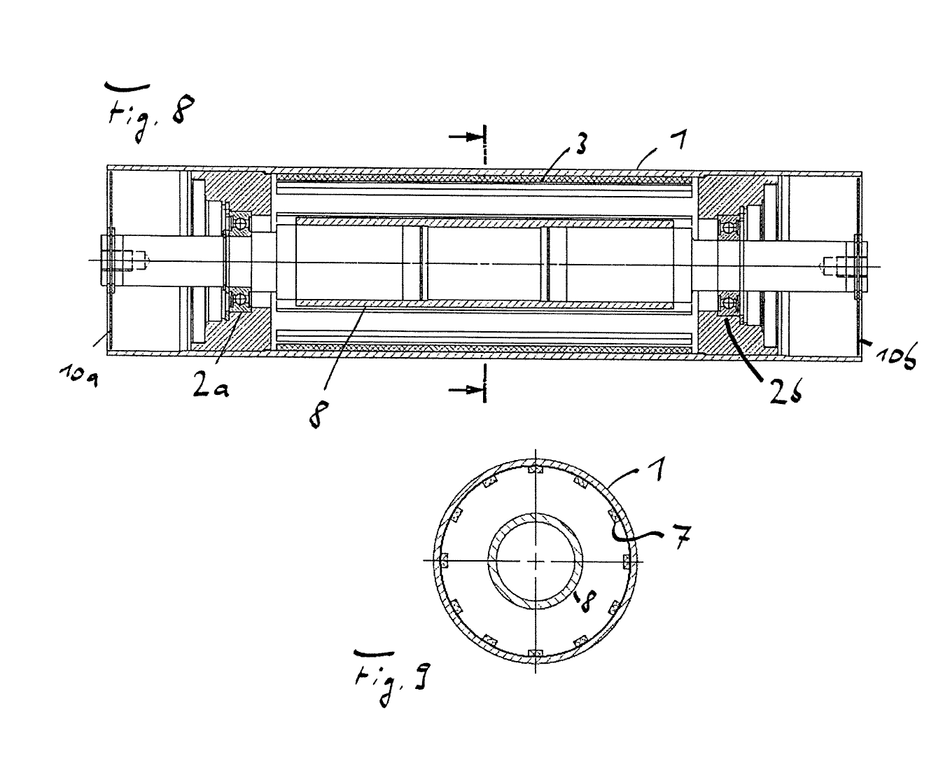

FIG. 8 and FIG. 9 show a longitudinal or cross-sectional view of a roll assembly according to a fifth embodiment of this invention. This embodiment exhibits as reinforcement only the strips 7 of fiber composite but no pipe of fiber composite.

Materials for the reinforcement of fiber composite may be multi-filament carbon fibers or polyacrylnitrile-based fibers, which preferably are carbonized by pyrolysis or refined by graphitization into Ultra High Modulus (UHM) fibers. The fibers can be embedded into a matrix, in particular into a thermoset matrix or a resin matrix (typically epoxy resin).

The fibers of the entire reinforcement are preferably directed into the longitudinal direction (in relation to the roll axis). When strips are used, it is also possible that the alternatively or in addition run at an angle of 30-60° to the longitudinal direction and may be configured cross-wise.

In all embodiments, the reinforcement can be inserted in a condition in which the matrix or the epoxy is not hardened yet. This creates a tight bond between the reinforcement and the roll. Alternatively, the reinforcement can also be molded ahead of time and then inserted and glued into the roll.

After the assembly, the roll is balanced, wherein—if necessary—balancing weights are added and glued into the roll at the appropriate positions.

The rotational bearings are shown as ball bearings in the embodiments. Friction is bearings or air bearings can be used as well.

1. A device comprising:
a roll assembly comprising
a roll,
two rotational bearings, and
a reinforcement member formed from a fiber composite and arranged inside the roll.

2. The device according to claim 1, wherein the fiber composite reinforcement member is located between the rotational bearings within the roll and configured and disposed to reinforce the roll against bending stress.

3. The device according to claim 1, characterized in that the reinforcement member comprises a fiber composite material pipe disposed against an inside surface of the roll.

4. The device according to claim 1, characterized in that the fiber composite reinforcement member comprises fiber composite material strips running in parallel to the roll axis and arranged inside the roll to extend radially outward from the roll axis.

5. The device according to claim 4, characterized in that the fiber composite reinforcement member comprises a supporting pipe arranged to support the fiber composite material strips from the inside.

6. The device according to claim 1, further comprising a shaft extending along the entire length of the roll, wherein the rotational bearings are mounted on the shaft.

7. The device according to claim 1, further comprising shaft sections, wherein the rotational bearings are mounted on shaft sections that are separate from each other.

8. The device according to claim 1, wherein one and only one rotational bearing is located at each end of the roll.

9. The device according to claim 1, characterized in that the ratio of the distance of the radial line of action of the rotational bearing to the total length of the roll is in a range of 0.015 to 0.05.

10. The device according to claim 1, characterized in that the ratio of the outer diameter of the roll to the total length of the roll in a range of 0.03 to 0.1.

11. The device according to claim 1, characterized in that the ratio of the wall thickness of the roll in the area between the rotational bearings to the outer diameter of the roll lies in a range of 0.01 to 0.08.

12. The device according to claim 1, characterized in that the ratio of the wall thickness of the fiber composite pipe to the wall thickness of the roll in the area between the rotational bearings is in a range from 0.2 to 1.0.

13. The device according to claim 1, further comprising roll covers located at the ends of the shaft, wherein air gaps are defined between the roll covers and the roll.

14. The device according to claim 13, characterized in that the air gaps are defined around an inner circumference of the roll covers and have a size of 0.3 to 2 mm.

15. A rotary printing machine comprising:
a roll assembly comprising
a roll,
two rotational bearings, and
a reinforcement member formed from a fiber composite and arranged inside the roll.

16. A printing press comprising:
a collection of deflection rolls that are neither actively driven nor actively stopped, each deflection role comprising
a generally tubular roll body having an inner surface and an outer surface, the inner surface of the roll body defining a roll body interior and the outer surface of the roll body disposed within the printing press to deflect a paper web;
two or more rotational bearings upon which the roll body is rotably mounted;
a fiber composite reinforcement member disposed within the roll body interior and in contact with the inner surface of the roll body, the fiber composite reinforcement member disposed and configured to reinforce the roll body against deformation due to deflection of the paper web by the outer surface of the roll body.
